(19) United States
(12) Patent Application Publication
(10) Pub. No.: US 2017/0256782 A1
(43) Pub. Date: Sep. 7, 2017

(54) PRE-DOPED ANODES AND METHODS AND APPARATUSES FOR MAKING SAME

(71) Applicant: Maxwell Technologies, Inc., San Diego, CA (US)

(72) Inventors: Santhanam RAMAN, San Diego, CA (US); Xiang-Rong YE, San Diego, CA (US); Xiaomei XI, Carlsbad, CA (US)

(21) Appl. No.: 15/442,261

(22) Filed: Feb. 24, 2017

Related U.S. Application Data
(60) Provisional application No. 62/302,092, filed on Mar. 1, 2016.

(51) Int. Cl. H01M 4/04; H01M 4/587; H01G 11/34; H01G 11/06; H01G 11/28; H01M 10/0525; H01G 11/52

(52) U.S. Cl. CPC H01M 4/0447; H01M 10/0525; H01M 4/587; H01G 11/52; H01G 11/06; H01G 11/28; H01G 11/34; H01M 2004/027

(57) ABSTRACT

An energy storage device can include a cathode, an anode, and a separator between the cathode and the anode, where the anode can have a desired lithium pre-doping level to facilitate desired capacitor performance. Controlled anode pre-doping can include printing lithium powder or a mixture including lithium powder onto a surface of the anode. Controlled anode pre-doping can include electrochemically incorporating lithium ions into the anode. A duration of the pre-doping process can be selected such that desired anode pre-doping is achieved.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND

Field

The present invention relates to energy storage devices, particularly to pre-doped anodes, and methods and apparatuses for making energy storage anodes.

Description of the Related Art

Various types of energy storage devices can be used to power electronic devices, including for example, capacitors, batteries, capacitor-battery hybrids and/or fuel cells. Energy storage devices, such as lithium ion capacitors and/or lithium ion batteries, can have a variety of shapes (e.g., prismatic, cylindrical and/or button shaped), and can be used in various applications. Lithium ions can be incorporated into the anode of a lithium ion capacitor and/or a lithium ion battery through a pre-doping process.

### SUMMARY

For purposes of summarizing the invention and the advantages achieved over the prior art, certain objects and advantages of the invention are described herein. Not all such objects or advantages may be achieved in any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

In a first aspect, an energy storage device is provided, comprising a cathode, an anode comprising intercalated lithium ions, and a separator between the cathode and the anode, wherein the intercalated lithium ions are present in an amount selected to limit lithium metal plating and to limit gassing, and wherein the amount of intercalated lithium ions corresponds to an anode voltage of about 0.05 to about 0.3 V compared to an Li/Li+ reference voltage.

In an embodiment of the first aspect, the energy storage device has an open circuit cell voltage of 2.7 V to 2.95 V following pre-doping and before use. In another embodiment of the first aspect, the lithium metal plating occurs at an anode voltage of about 0 V compared to an Li/Li+ reference voltage. In another embodiment of the first aspect, the gassing occurs at a cathode voltage of about 4 V compared to an Li/Li+ reference voltage. In another embodiment of the first aspect, the energy storage device further comprises an electrolyte comprising a lithium salt. In another embodiment of the first aspect, the electrolyte further comprises a carbonate. In another embodiment of the first aspect, the anode comprises an electrode film mixture comprising a carbon material selected from graphite, hard carbon, and soft carbon. In another embodiment of the first aspect, the anode comprises an electrical conductivity promoting material. In another embodiment of the first aspect, the energy storage device is a capacitor. In another embodiment of the first aspect, the anode comprises a dry, free-standing electrolyte film and a current collector.

In a second aspect, an energy storage device is provided, comprising a first electrode comprising lithium ions adsorbed to a first electrode surface, a second electrode, a separator between the first electrode and the second electrode, and an electrolyte comprising a lithium salt, wherein the lithium ions are present on the first electrode surface in an amount corresponding to a first electrode voltage of about 0.05 to about 0.3 V following pre-doping, and before use, compared to an Li/Li+ reference voltage.

In an embodiment of the second aspect, the energy storage device has an open circuit cell voltage of 2.7 V to 2.95 V following pre-doping, and before use. In another embodiment of the second aspect, the first electrode and the second electrode each comprise a dry, free-standing electrode film and a current collector. In another embodiment of the second aspect, the first electrode and the second electrode each comprise an electrode film substantially free from processing additives. In another embodiment of the second aspect, the lithium salt is lithium hexafluorophosphate (LiPF₆). In another embodiment of the second aspect, the electrolyte further comprises a carbonate. In another embodiment of the second aspect, the carbonate is selected from the group consisting of ethylene carbonate (EC), propylene carbonate (PC), vinyl ethylene carbonate (VEC), vinylene carbonate (VC), fluoroethylene carbonate (FEC), dimethyl carbonate (DMC), diethyl carbonate (DEC), ethyl methyl carbonate (EMC), and combinations thereof. In another embodiment of the second aspect, the first electrode comprises a carbon material selected from graphite, hard carbon, soft carbon, and combinations thereof. In another embodiment of the second aspect, the first electrode further comprises an electrical conductivity promoting material. In another embodiment of the second aspect, the energy storage device is a capacitor.

In a third aspect, a method for fabricating an energy storage device is provided, comprising electrically coupling a lithium metal source and an electrode film, and doping the electrode film with lithium ions to a predetermined electrode voltage of about 0.05 to about 0.3 V compared to an Li/Li+ reference voltage.

In an embodiment of the third aspect, the electrode is an anode. In another embodiment of the third aspect, the electrode film is a capacitor electrode film. In another embodiment of the third aspect, the predetermined electrode voltage is selected to limit lithium metal plating and to limit gassing. In another embodiment of the third aspect, the electrode film is manufactured by a dry process. In another embodiment of the third aspect, the electrode film is a free-standing electrode film.

### BRIEF DESCRIPTION OF THE DRAWINGS

These and other features, aspects, and advantages of the present disclosure are described with reference to the drawings of certain embodiments, which are intended to illustrate certain embodiments and not to limit the invention.

FIG. 1 shows a side cross-sectional schematic view of an example of an energy storage device, according to one embodiment.

FIG. 2 is a graph showing the voltage swing profile of a lithium ion capacitor anode during charge and discharge cycling, where the anode pre-doping level corresponded to an open circuit cell voltage of about 2.4 Volts (V) and the pre-doping process was performed for a duration of about 72 hours.

FIG. 3 is a graph showing the voltage swing profile of a lithium ion capacitor anode during charge and discharge cycling, where the anode pre-doping level corresponded to an open circuit cell voltage of about 2.7 V and the pre-doping process was performed for a duration of about 72 hours.

FIG. 4 is a graph showing the voltage swing profile of a lithium ion capacitor anode during charge and discharge cycling, where the anode pre-doping level corresponded to an open circuit cell voltage of about 2.8 V and the pre-doping process was performed for a duration of about 96 hours.

FIG. 5 is a graph showing the cyclic voltammetry performance of a cathode of a large 3.8 V lithium ion capacitor pouch cell.

FIGS. 6A through 6C are graphs showing voltage swing of the cathode and anode of a large 3.8 V lithium ion capacitor pouch cell cycled between a cell voltage of about 2.2 V and 3.8 V.

FIG. 7 depicts an apparatus for pre-doping an anode of an energy storage device according to an embodiment.

### DETAILED DESCRIPTION

Although certain embodiments and examples are described below, those of skill in the art will appreciate that the invention extends beyond the specifically disclosed embodiments and/or uses and obvious modifications and equivalents thereof. Thus, it is intended that the scope of the invention herein disclosed should not be limited by any particular embodiments described below.

Carbon anode materials used in lithium ion capacitors can have significant irreversible capacity loss, which can lead to poor electrochemical performance of the lithium ion capacitor. Pre-doping of a lithium ion-based energy storage device provides metal ions to occupy surface active sites in the electrodes of the device, improving the performance of the device. However, under some less desirable conditions, pre-doping of lithium ions at the anode of an energy storage device can contribute to deleterious conditions in the cell. For example, as a cell is cycled, the voltage at the anode and cathode of the cell rises and falls. If the voltage at either electrode reaches or exceeds a critical value, the cell may lose performance or become inoperable.

Without wishing to be limited by theory, it is thought that formation of lithium metal at the anode can damage a cell. For example, dendrites may cause the separator of the lithium ion capacitor to disconnect and become isolated from the electrolyte. Dendrites may pierce through the separator. Dead lithium and dendrites may cause a short circuit, thermal runaway, and/or other problematic symptoms. Lithium plating, which can include formation of these lithium dendrites, on an anode surface may occur due to accumulation of lithium over the surface of the anode, for example rather than intercalation of the lithium into the anode. Carbon materials may be susceptible to lithium plating because of the close proximity of its reversible potential to that of Li⁺/Li. It is thought that lithium metal plating occurs when the voltage of the anode reaches, or closely approaches the reduction voltage of lithium, which is to say, at a 0 V value, or very slightly above 0 V (e.g., 0.01 V or less), compared to an Li/Li+ reference voltage. It is further thought that the voltage at the anode corresponds to the amount of lithium ions intercalated at available site on the surface of the anode, and within porous structures of the anode. Thus, the amount of lithium ions at the anode surface should not reach or exceed a critical value, which depends on conditions in the overall energy storage device, as explained herein. As used herein, an “Li/Li+ reference voltage” refers to the voltage potential for the half reaction: Li→Li⁺_+e⁻.

Gassing within the cell can also be problematic. To explain, the process of doping of lithium ions which are pre-doped in the anode leads to the accumulation of a voltage at the cathode of an energy storage device. Without wishing to be limited by theory, it is thought that the voltage at the cathode leads to formation of a solid-electrolyte interphase layer (SEI). Generally, it is thought that the SEI layer includes negatively charged species on the surface and within the porous structure of the electrode. The negatively charged species are thought to result from reduction of reducible components of the electrolyte, and impurities present in the electrolyte. It is thought that the solid electrolyte interface (SEI) is formed at higher potentials than those of the insertion of Li ions into carbon anode. The SEI layer may include inorganic species, for example, lithium carbonate and organic species, for example, lithium alkyl carbonate. In some embodiments, the reducible components of the electrolyte in formation of an SEI layer are one or more carbonates as provided herein.

When the anode is pre-doped with too few lithium ions, the cathode voltage may reach or exceed a critical value during cell cycling. The critical value may correspond to deleterious processes in the cell, for example, gassing. Without wishing to be limited by theory, it is thought that gassing of the cell occurs when acidic species are reduced to form hydrogen and/or hydrocarbon gasses. Some gas may be generated during SEI formation, and further gas generation may accompany growth of the SEI layer due to the parasitic solvent reduction or the failure of the pre-formed SEI layer. In some embodiments, the anode voltage following pre-doping is selected to limit gas production in the cell.

Generally, once a cell of an energy storage device is in operation (e.g., charge and discharge cycling), the cell voltage modulates between a selected “charged” voltage, and a selected “discharged” voltage. Thus, when a cell is charged, the open circuit voltage of the cell rises, eventually reaching a maximum threshold, and when a cell is discharged, the voltage of the cell drops, eventually reaching a minimum threshold (referred to herein as a voltage “swing”). The voltage at each electrode rises and/or falls along with the overall cell voltage. If the cell voltage reaches or exceeds a critical value deleterious effects, such as those described herein, may result.

In some embodiments, an energy storage device, such as a lithium ion capacitor (LiC), with improved electrical performance characteristics is provided. In some embodiments, the lithium ion capacitor comprises an anode with a predetermined, desired pre-doping level to facilitate desired capacitor performance. In some embodiments, one or more pre-doping processes are described herein to provide controlled pre-doping of the anode. In some embodiments, an anode pre-doping process comprises printing lithium powder or a mixture comprising lithium powder onto a surface of the anode. In some embodiments, an anode pre-doping process comprises electrochemically incorporating lithium ions into the anode.

In some embodiments, one or more pre-doping processes described herein can compensate for the irreversible capacity loss experienced by the anode following cycling operations. In some embodiments, a duration of the pre-doping process can be selected such that desired anode pre-doping is achieved. In some embodiments, one or more lithium ion capacitors described herein can have an operating voltage of about 2.2 V to about 3.8 V.

A lithium ion capacitor including one or more anodes comprising a pre-doping level and/or pre-doped using one or more processes described herein may advantageously demonstrate reduced equivalent series resistance (ESR), thereby providing a capacitor with increased power density.

In some embodiments, lithium ion capacitors including one or more anodes comprising a pre-doping level and/or pre-doped using one or more processes described herein can demonstrate decreased irreversible capacity loss, improved cycling performance, including improved capacitance stability during cycling, such as reduced capacitance fade.

In some embodiments, one or more processes and/or apparatuses described herein can be applied to lithium ion capacitors of various configurations, including for example planar, spirally wound and/or button shaped lithium ion capacitors. In some embodiments, one or more processes and/or apparatuses described herein can be applied to lithium ion capacitors used in power generation systems, uninterruptible power source systems (UPS), photo voltaic power generation, energy recovery systems in industrial machinery and/or transportation systems. The lithium ion capacitors may be used to power various electronic device and/or motor vehicles, including hybrid electric vehicles (HEV), plug-in hybrid electric vehicles (PHEV), and/or electric vehicles (EV) vehicles.

It will be understood that although the processes and/or apparatuses may be primarily described herein within a context of lithium ion capacitors, the embodiments can be implemented with any of a number of energy storage devices and systems, such as one or more batteries, capacitors, capacitor-battery hybrids, fuel cells, combinations thereof, and the like. In some embodiments, the processes and/or apparatuses described herein may be implemented with lithium ion batteries.

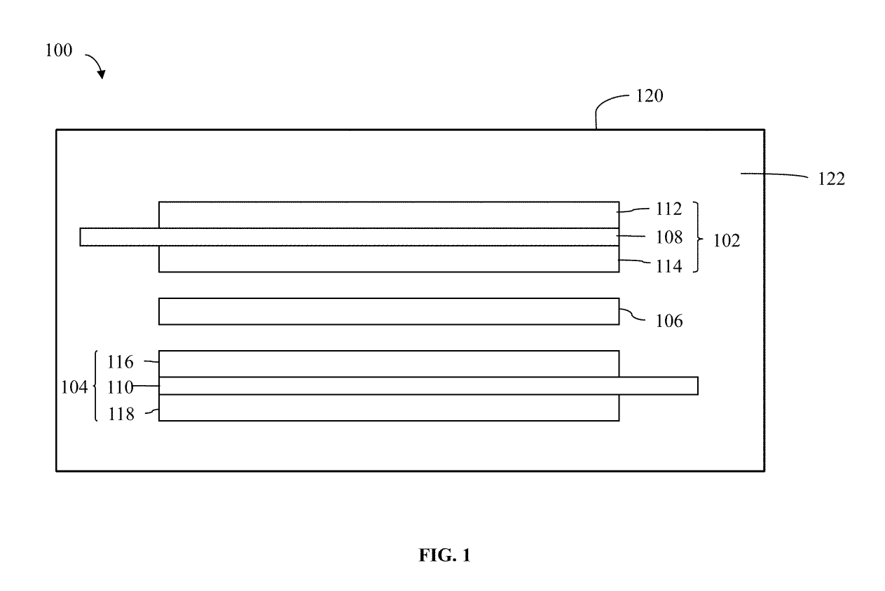

FIG. 1 shows a side cross-sectional schematic view of an example of an energy storage device 100. The energy storage device 100 may be a lithium ion capacitor. Of course, it should be realized that other energy storage devices are within the scope of the invention, and can include batteries, capacitor-battery hybrids, and/or fuel cells. The energy storage device 100 can have a first electrode 102, a second electrode 104, and a separator 106 positioned between the first electrode 102 and second electrode 104. For example, the first electrode 102 and the second electrode 104 may be placed adjacent to respective opposing surfaces of the separator 106. The first electrode 102 may comprise a cathode and the second electrode 104 may comprise an anode, or vice versa. The energy storage device 100 may include an electrolyte 122 to facilitate ionic communication between the electrodes 102, 104 of the energy storage device 100. For example, the electrolyte may be in contact with the first electrode 102, the second electrode 104 and the separator 106. The electrolyte, the first electrode 102, the second electrode 104, and the separator 106 may be received within an energy storage device housing 120. For example, the energy storage device housing 120 may be sealed subsequent to insertion of the first electrode 102, the second electrode 104 and the separator 106, and impregnation of the energy storage device 100 with the electrolyte 122, such that the first electrode 102, the second electrode 104, the separator 106, and the electrolyte 122 may be physically sealed from an environment external to the housing.

The energy storage device 100 can include any of a number of different types of electrolyte 122. For example, device 100 can include a lithium ion capacitor electrolyte 122, which can include a lithium source, such as a lithium salt, and a solvent, such as an organic solvent. In some embodiments, a lithium salt can include hexafluorophosphate (LiPF₆), lithium tetrafluoroborate (LiBF₄), lithium perchlorate (LiClO₄), lithium bis(trifluoromethansulfonyl)imide (LiN(SO₂CF₃)₂), lithium trifluoromethansulfonate (LiSO₃CF₃), combinations thereof, and/or the like. In some embodiments, a lithium ion capacitor electrolyte solvent can include one or more carbonates, nitriles, ethers or esters, and combinations thereof. The carbonate can be a cyclic carbonate such as, for example, ethylene carbonate (EC), propylene carbonate (PC), vinyl ethylene carbonate (VEC), vinylene carbonate (VC), fluoroethylene carbonate (FEC), and combinations thereof, or an acyclic carbonate such as, for example, dimethyl carbonate (DMC), diethyl carbonate (DEC), ethyl methyl carbonate (EMC), and combinations thereof. For further example, a lithium ion capacitor electrolyte solvent may comprise ethylene carbonate (EC), dimethyl carbonate (DMC), diethyl carbonate (DEC), ethyl methyl carbonate (EMC), vinyl carbonate (VC), propylene carbonate (PC), combinations thereof, and/or the like. For example, the electrolyte 122 may comprise LiPF₆, ethylene carbonate, propylene carbonate and diethyl carbonate.

The separator 106 can be configured to electrically insulate two electrodes adjacent to opposing sides of the separator 106, such as the first electrode 102 and the second electrode 104, while permitting ionic communication between the two adjacent electrodes. The separator 106 can comprise a variety of porous electrically insulating materials. In some embodiments, the separator 106 can comprise a polymeric material. For example, the separator 106 can comprise a cellulosic material (e.g., paper), a polyethylene (PE) material, a polypropylene (PP) material, and/or a polyethylene and polypropylene material.

As shown in FIG. 1, the first electrode 102 and the second electrode 104 include a first current collector 108, and a second current collector 110, respectively. The first current collector 108 and the second current collector 110 may facilitate electrical coupling between the corresponding electrode and an external circuit (not shown). The first current collector 108 and/or the second current collector 110 can comprise one or more electrically conductive materials, and/or have various shapes and/or sizes configured to facilitate transfer of electrical charges between the corresponding electrode and a terminal for coupling the energy storage device 100 with an external terminal, including an external electrical circuit. For example, a current collector can include a metallic material, such as a material comprising aluminum, nickel, copper, silver, alloys thereof, and/or the like. For example, the first current collector 108 and/or the second current collector 110 can comprise an aluminum foil having a rectangular or substantially rectangular shape and can be dimensioned to provide desired transfer of electrical charges between the corresponding electrode and an external electrical circuit (e.g., via a current collector plate and/or another energy storage device component configured to provide electrical communication between the electrodes and the external electrical circuit).

The first electrode 102 may have a first electrode film 112 (e.g., an upper electrode film) on a first surface of the first current collector 108 (e.g., on a top surface of the first current collector 108) and a second electrode film 114 (e.g., a lower electrode film) on a second opposing surface of the first current collector 108 (e.g., on a bottom surface of the first current collector 108). Similarly, the second electrode 104 may have a first electrode film 116 (e.g., an upper electrode film) on a first surface of the second current collector 110 (e.g., on a top surface of the second current collector 110), and a second electrode film 118 on a second opposing surface of the second current collector 110 (e.g., on a bottom surface of the second current collector 110). For example, the first surface of the second current collector 110 may face the second surface of the first current collector 108, such that the separator 106 is adjacent to the second electrode film 114 of the first electrode 102 and the first electrode film 116 of the second electrode 104.

The electrode films 112, 114, 116 and/or 118 can have a variety of suitable shapes, sizes, and/or thicknesses. For example, the electrode films can have a thickness of about 30 microns (μm) to about 250 microns, including about 100 microns to about 250 microns.

In some embodiments, an electrode film, such as one or more of electrode films 112, 114, 116 and/or 118, can have a mixture comprising binder material and carbon. In some embodiments, the electrode film can include one or more additives, including electrical conductivity promoting additives. The electrical conductivity promoting additive may comprise a conductive carbon, such as carbon black. In some embodiments, the electrode film of a lithium ion capacitor cathode can comprise an electrode film mixture comprising one or more carbon based electroactive components, including for example a porous carbon material. In some embodiments, the porous carbon material of the cathode comprises activated carbon. For example, the electrode film of the cathode and can include a binder material, activated carbon and an electrical conductivity promoting additive. In some embodiments, the electrode film of a lithium ion capacitor anode comprises an electrode film mixture comprising carbon configured to reversibly intercalate lithium ions. In some embodiments, the lithium intercalating carbon is graphite, hard carbon and/or soft carbon. For example, the electrode film of the anode can include a binder material, one or more of graphite, hard carbon and soft carbon, and an electrical conductivity promoting additive. In some embodiments, an electrode film can be pre-doped with lithium as provided herein. In further embodiments, the pre-doped lithium can be intercalated and/or adsorbed in one or more surfaces and/or pores of the electrode film. It will be understood that embodiments described herein can be implemented with one or more electrodes, and with electrode(s) that have one or more electrode films, and should not be limited to the embodiment shown in FIG. 1.

In some embodiments, the binder material can include one or more fibrillizable binder components. For example, a process for forming an electrode film can include fibrillizing the fibrillizable binder component such that the electrode film comprises fibrillized binder. The binder component may be fibrillized to provide a plurality of fibrils, the fibrils providing desired mechanical support for one or more other components of the film. For example, a matrix, lattice and/or web of fibrils can be formed to provide desired mechanical structure for the electrode film. For example, a cathode and/or an anode of a lithium ion capacitor can include one or more electrode films comprising one or more fibrillized binder components. In some embodiments, a binder component can include one or more of a variety of suitable fibrillizable polymeric materials, such as polytetrafluoroethylene (PTFE), ultra-high molecular weight polyethylene (UHMWPE), and/or other suitable fibrillizable materials, used alone or in combination.

In some embodiments, one or more electrode films described herein can be fabricated using a dry fabrication process. As used herein, a dry fabrication process can refer to a process in which no or substantially no solvents are used in the formation of an electrode film. For example, components of the electrode film may comprise dry particles. The dry particles for forming the electrode film may be combined to provide a dry particles electrode film mixture. In some embodiments, the electrode film may be formed from the dry particles electrode film mixture using the dry fabrication process such that weight percentages of the components of the electrode film and weight percentages of the components of the dry particles electrode film mixture are similar or the same. In some embodiments, the electrode film formed from the dry particles electrode film mixture using the dry fabrication process may be free or substantially free from any processing solvents, and solvent residues resulting therefrom. In some embodiments, the electrode films are free-standing dry particle electrode films formed using the dry process from the dry particles mixture. In some embodiments, a dry electrode film can be formed from the dry process using a single, fibrillizable binder, such as PTFE, without additional binders.

### Pre-Doping by Printing

In some embodiments, a process for pre-doping anodes can comprise a printing process. In some embodiments, the printing process can be used to pre-dope anodes of lithium ion capacitors. In some embodiments, the printing process can be used to pre-dope anodes of lithium ion batteries. In some embodiments, the pre-doping process comprises printing a lithium powder or a mixture comprising lithium powder. In some embodiments, the mixture can include lithium powder, carbon, a binder material and/or a solvent. In some embodiments, the pre-doping process includes printing the lithium powder or the mixture onto a surface of the anode. In some embodiments, such a printing process facilitates controlled incorporation of lithium metal into the anode. Printing the lithium powder or mixture onto the anode can be performed during or after the anode fabrication process. The pre-doped anode can be subsequently assembled as part of a lithium ion capacitor or lithium ion battery.

In some embodiments, the printing process comprises loading the lithium powder or the mixture comprising the lithium powder into a printer cartridge of a programmable printer, and subsequently printing the lithium powder or mixture onto a desired portion of the anode, such as directly onto a surface of the anode. In some embodiments, the cartridge and/or print head may be heated and/or pressurized during the printing process. In some embodiments, the programmable printer can be programmed to control the amount, thickness, location and/or pattern of the printed lithium powder or mixture. Control of the amount, thickness, location and/or pattern of the printed lithium powder or mixture may improve control in the level of anode pre-doping, thereby reducing irreversible capacity loss and/or improved cycling performance. The printed lithium powder or mixture may provide a localized site for introducing lithium into the anode, and/or increased rate of lithium ion intercalation. Use of a printing process may facilitate a continuous pre-doping process, for example facilitating a pre-doping process amenable to scale-up.

In some embodiments, the printing process can be applied to lithium ion capacitors and/or lithium ion batteries, such as lithium ion capacitors and/or lithium ion batteries comprising anodes which include hard carbon and/or graphite. The printing process may facilitate controlled pre-doping of anodes of lithium ion capacitors and/or lithium ion batteries. For example, pre-doping of lithium ion battery anodes may provide lithium ions for the battery such that not all lithium for the lithiation of anode comes from poorly conductive and metastable active materials of the battery cathode, thereby reducing capacity loss, equivalent series resistance, cost of fabrication, and/or improving energy density, power density, life time, and/or safety. In some embodiments, the printing process facilitates use of new materials, such as material with large reversible and/or irreversible capacities, for lithium ion battery anodes. For example, lithium ion battery anodes may no longer be limited to graphite. In some embodiments, the printing process facilitates use of Si composite and Sn intermetallics in lithium ion battery anodes. In some embodiments, the printing process facilitates use of new materials for lithium ion battery cathodes. For example, lithium ion battery cathodes may no longer be limited to lithium providing materials. In some embodiments, the printing process facilitates use of non-lithium providing materials in cathodes, for example materials which can be used to achieve higher capacities, lower equivalent series resistance, more overcharge tolerant, higher energy density, higher power density, improved safety and/or reduced cost of fabrication.

In some embodiments, the printing process may facilitate achieving desired pre-doping in a shorter period of time, simplify the pre-doing process, and/or scale-up of controlled pre-doping process, when compared to other pre-doping processes, such as a pre-doping process which shorts the anode with a sacrificial lithium electrode, such as lithium foil. In some embodiments, the printing process may facilitate achieving desired pre-doping in a shorter period of time, simplify the pre-doing process, and/or scale-up of controlled pre-doping process, such as compared to pre-doping by coating a lithium powder suspension on the surface of pre-fabricated anode sheet without changing the existing anode fabrication process, or including lithium powder in the slurry mix when the anode sheet is being cast therefore no additional step but the slurry needs to be compatible with lithium.

The anode was dried and transferred to dry box. Stabilized lithium metal powder (SLMP®) (FMC Corporation) was printed to the electrode surface using a printing screen and the printed electrode was pressed by a roller. The Li printed anode was then assembled into a half cell and soaked with electrolyte (1M LiPF₆ in EC/EMC 3:7). The anode voltage relative to Li electrode was measured after 48 hours of storage. Table 1 provides the lithiation level vs Li powder loading.

TABLE 1
Anode lithiation vs. Li powder loading

| | Li powder printing load (mg/cm²) | | | | |
|---|---|---|---|---|---|
| | 0 | 0.5 | 0.7 | 0.9 | 1.1 |
| Anode | 3 | 1 | 0.6 | 0.5 | 0.4 |
| Voltage vs. | | | | | |
| Li⁺/Li (V) | | | | | |

An anode with active material loading of 7.5 mg/cm² was used for the evaluation of Li powder printing experiments.

### Electrochemical Pre-Doping

In some embodiments, a method of pre-doping an anode comprises electrochemically incorporating lithium ions into the anode, such as by using an electrolyte. In some embodiments, electrochemically incorporating lithium ions into the anode comprises using a non-aqueous electrolyte. In some embodiments, the non-aqueous electrolyte comprises all or substantially all of the dissociable lithium ions in the electrolyte and moving lithium ions from the cathode of the resulting assembled lithium ion capacitor. In some embodiments, electrochemically incorporating lithium ions into the anode can avoid insertion of a sacrificial lithium metal electrode into the lithium ion capacitor as the lithium source, simplifying the lithium ion capacitor fabrication process, and/or reducing or avoiding device safety problems associated with the inserted sacrificial lithium electrode. In some embodiments, electrochemically incorporating lithium ions rather than using a sacrificial lithium electrode can increase capacitor energy density, for example due to a decrease in weight of the capacitor. In some embodiments, a lithium ion capacitor comprising an electrochemically pre-doped anode may demonstrate improved reversible capacity, and/or irreversibly capacity loss. In some embodiments, a lithium ion capacitor comprising an electrochemically pre-doped anode may demonstrate improved coulombic efficiency and/or electrochemical performance.

In some embodiments, electrochemically incorporating lithium ions into the anode comprises providing a lithium ion capacitor cell with a non-aqueous electrolyte configured to be a lithium ion source, and applying a voltage in a three-electrode environment. The three-electrode environment can include a working electrode, a counter electrode and a reference electrode. The working electrode may comprise the lithium ion capacitor anode. In some embodiments, the counter electrode may comprise, for example, lithium metal or platinum metal. In some embodiments, the reference electrode may comprise, for example, lithium metal, or silver metal, such as a silver wire. For example, the three-electrode environment may include a working electrode comprising the lithium ion capacitor anode, a counter electrode comprising platinum metal, and a reference electrode comprising lithium metal. In some embodiments, a voltage can be applied between the reference electrode and the working electrode such that lithium ion from the non-aqueous electrolyte can be pre-doped into the working electrode. In some embodiments, a current can be measured between the counter electrode and the working electrode. In some embodiments, the voltage applied between the working electrode, such as the lithium ion capacitor anode, and the reference electrode can be applied for a duration of time so as to achieve desired pre-doping of the lithium ion capacitor anode. In some embodiments, a constant or a substantially constant voltage can be applied for the duration. For example, a particular voltage can be applied between the anode and the reference electrode for a duration such that desired pre-doping of the anode can be achieved. In some embodiments, a pre-doping process comprising the electrochemical incorporation of lithium ions into the anode can achieve desired pre-doping in a shorter period of time. For example, desired pre-doping can be achieved between about 10 to about 20 hours, and in some embodiments, in as little as about 5 hours.

In some embodiments, an electrochemical pre-doping can be performed at various times relative to completion of the fabrication process of the energy storage device. For example, the electrochemical pre-doping process can be performed as part of an initial charge and/or discharge of the lithium ion capacitor. In some embodiments, the pre-doping process comprising electrochemical incorporation of lithium ions into the anode can be performed prior to initial charge of the lithium ion capacitor. In some embodiments, the pre-doping process can be performed prior to the final packaging step in the fabrication process. For example, the pre-doping process may be performed prior to final packaging, for example, prior to sealing of the lithium ion capacitor. In some embodiments, performing the pre-doping process prior to final packaging can reduce or avoid subsequent disturbance of any solid electrolyte interphase (SEI) layer surface layer formed over the anode during the pre-doping process. For example, lithium ions may be transferred through the same solid electrolyte interphase layer formed in the pre-doping step during subsequent charging and/or discharging of the lithium ion capacitor. In some embodiments, the pre-doping process comprising electrochemical incorporation of lithium ions into the anode may facilitate providing a lithium ion capacitor which can reduce the duration of the first full charging step of the assembled capacitor, relative to conventional capacitors.

### Selecting a Level of Pre-Doping

It has been discovered that the level of pre-doping of lithium at the anode of an energy storage device can be selected to provide improved performance of an energy storage device. The present disclosure reveals that the amount of lithium metal at the surface of the anode can be tuned by selecting an appropriate voltage at the anode. In some embodiments, the level of pre-doping is selected to avoid critical voltages, as provided herein, during cell cycling. In some embodiments, a duration of the pre-doping process and/or the pre-doping level of the anode achieved by the pre-doping process can be selected to provide a lithium ion capacitor which can demonstrate desired electrical performance.

It is believed that an anode comprising a pre-doping level that exceeds the critical pre-doping level may result in lithium plating on the anode. In some embodiments, a duration of the pre-doping process and/or the pre-doping level of the anode can be selected to reduce or eliminate lithium plating, such as dendrite formation, on the anode. In some instances, the anode voltage can be determined by measuring open circuit cell voltage, which is the no-load voltage between the anode and cathode of the cell in which the anode is being doped.

Furthermore, as explained above, a lithium ion capacitor cathode voltage may exceed a critical value of about 4 V, and the cathode may exhibit gassing, if the anode pre-doping level is too low. For example, an increased pre-doping level may reduce gas formation. The pre-doping level should be selected such that neither the cathode nor the anode reaches a critical voltage during cycling. Thus, a pre-doping level can be selected to reduce or avoid both gas generation and lithium plating.

In some embodiments, a duration of the pre-doping process and/or the pre-doping level of the anode can be selected such that the minimum threshold of the voltage swing of the pre-doped anode stays above the lithium plating voltage (e.g., about 0.0 V compared to an Li/Li⁺ reference voltage) during charge and discharge cycling of the energy storage device, for example, the lithium ion capacitor. In some embodiments, a duration of the pre-doping process and/or the pre-doping level of the anode can be selected such that the maximum threshold of the voltage swing of the pre-doped anode stays below the critical gassing voltage at the cathode during charge and discharge cycling of the energy storage device. In some embodiments, avoiding the critical voltages during charge and discharge of the energy storage device can reduce or eliminate lithium plating of the anode and/or gassing at the cathode, thereby improving cycling performance, including during operation under high current rates. For example, lithium ion capacitors with reduced lithium plating at the anode and/or gassing at the cathode may demonstrate reduced capacitance fade performance, improved equivalent series resistance, and/or reduced device failure due to short-circuit and/or thermal runaway. In some embodiments, a lithium ion capacitor comprising an anode with a desired pre-doping level may be cycled for thousands, e.g., 1000 or more, cycles without or substantially without any lithium plating and/or cathode gassing, thereby demonstrating desired capacitance stability and/or equivalent series resistance performance.

A desired pre-doping level and/or pre-doping process duration may depend in part on the anode composition, composition of the electrolyte, and/or operating voltage of the energy storage device, for example, lithium ion capacitor. In some embodiments, a desired pre-doping level of the anode is reached when the open circuit voltage between the cathode and anode is about 2.7 Volts (V) to about 2.95 V.

In some embodiments, a lithium ion capacitor with an operating voltage of about 2.2 V to about 3.8 V can have a desired pre-doping level as provided herein. In some embodiments, an anode of an energy storage device can be pre-doped with an amount of lithium corresponding to an anode voltage of about 0.01 V to about 0.5 V, about 0.03 V to about 0.4 V, or preferably about 0.05 V to about 0.3 V, compared to an Li/Li⁺ reference voltage. In some embodiments, an anode of an energy storage device can be pre-doped with an amount of lithium corresponding to an anode voltage of about 0.01 V, about 0.03 V, about 0.05 V, about 0.07 V, about 0.1 V, about 0.15 V, about 0.2 V, about 0.25 V, about 0.3 V, about 0.35 V, about 0.4 V, about 0.45 V, or about 0.5 V compared to an Li/Li⁺ reference voltage. In some embodiments, an anode of an energy storage device can be pre-doped to about 30% lithiation, about 40% lithiation, about 50% lithiation, about 60% lithiation, about 70% lithiation, about 80% lithiation, or about 90% lithiation. In further embodiments, the lithium comprises or consists essentially of intercalated lithium ions. Some such ranges have been found to reduce or eliminate gassing and lithium plating on the anode. Although the description is provided with respect to a lithium ion capacitor, the materials and methods provided herein are applicable to any lithium ion energy storage device.

In some embodiments, an energy storage device comprising an anode having a desired pre-doping level as provided herein can be a lithium ion capacitor including an electrolyte comprising 1.0 Molar (M) LiPF₆ in a solvent comprising a mixture of two or three carbonates, such as two or more of EC, PC, DEC, DMC and EMC. In some embodiments, such a desired pre-doping level can be for a lithium ion capacitor including an anode comprising one or more of hard carbon, soft carbon, and graphite. In some embodiments, the anode comprises one or two of hard carbon, soft carbon, and graphite. For example, such a desired pre-doping level can be for a lithium ion capacitor with an operating voltage of about 2.2 V to about 3.8 V, including an anode comprising one or two of hard carbon, soft carbon and graphite, and an electrolyte having the composition: 1.0 Molar (M) LiPF₆ in a solvent comprising a mixture of two or three carbonates, such as two or more of EC, PC, DEC, DMC and EMC. For example, a pre-doping process may be terminated once the open circuit voltage between the anode and the cathode is about 2.7 Volts (V) to about 2.95 V. In some embodiments, the pre-doping process duration can be selected to avoid or reduce lithium plating at the anode. In some embodiments, the pre-doping process can be performed for a duration of about 0.1 to about 240 hours, for example, from about 1 to about 168 hours, about 5 to about 120 hours, about 24 to about 72 hours, about 72 hours to about 120 hours, or a range of values therebetween.

Table 2 provides data for anode and open circuit cell voltage for lithium ion capacitors including pre-doped anodes having selected lithium loading, as shown.

TABLE 2

| Anode | | |
|---|---|---|
| lithiation Voltage, | Cell voltage, | % of |
| (vs. Li⁺/Li, V) | (vs. Li⁺/Li, V) | Lithiation |
| 0.40 | 2.60 | 41 |
| 0.30 | 2.70 | 50 |
| 0.25 | 2.75 | 52 |
| 0.20 | 2.80 | 55 |
| 0.15 | 2.85 | 59 |
| 0.10 | 2.90 | 60 |
| 0.05 | 2.95 | 75 |

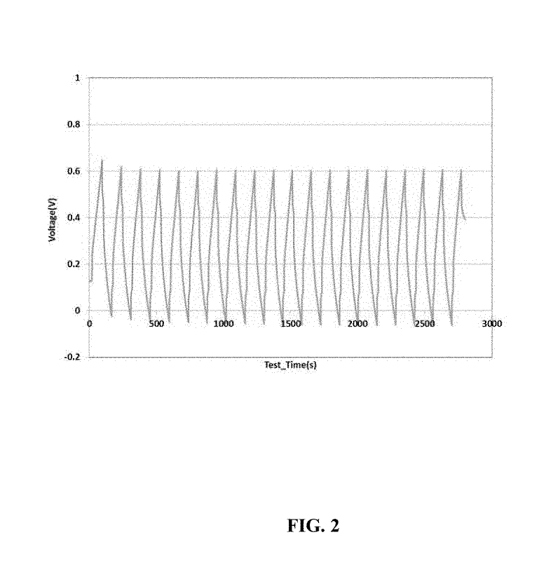

FIGS. 2-4 are graphs showing voltage swing profiles of lithium ion capacitor anodes which having various pre-doping levels and were subjected to pre-doping processes of various durations.

FIG. 2 is a graph showing the voltage swing profile of a lithium ion capacitor anode during charge and discharge cycling, where the anode pre-doping level was selected to correspond to an open circuit cell voltage of about 2.4 V and the pre-doping process was performed for a duration of about 72 hours. The graph shows the anode voltage on the y-axis in Volts (V) and the testing time in seconds (s) on the x-axis. The profile shows that the lowest voltage of the anode during the voltage swing at some points was lower than 0.0 V, for example indicating lithium plating occurred at the anode.

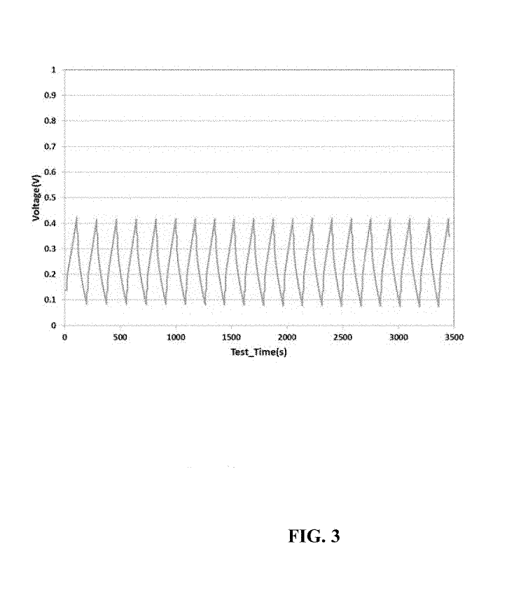

FIG. 3 is a graph showing the voltage swing profile of a lithium ion capacitor anode during charge and discharge cycling, where the anode pre-doping level was selected to correspond to an open circuit cell voltage of about 2.7 V and the pre-doping process was performed for a duration of about 72 hours. The graph shows the anode voltage on the y-axis in Volts (V) and the testing time in seconds (s) on the x-axis. The graph shows that the lowest electrode voltage during the voltage swing remains higher than 0.0 V, indicating for example that no or substantially no lithium plating occurred at the anode.

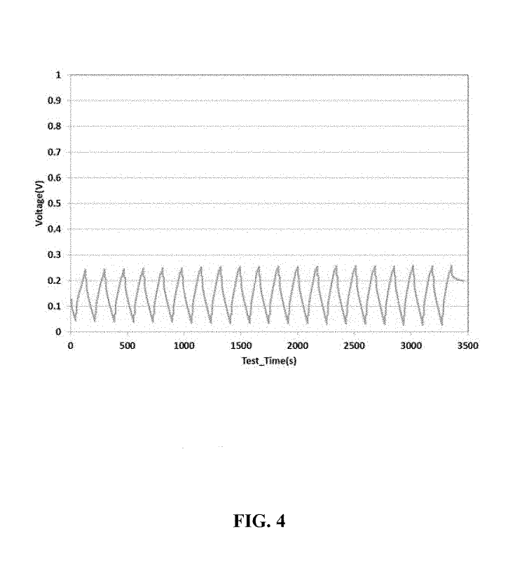

FIG. 4 is a graph showing the voltage swing profile of a lithium ion capacitor anode during charge and discharge cycling, where the anode pre-doping level was selected to correspond to an open circuit cell voltage of about 2.8 V and the pre-doping process was performed for a duration of about 96 hours. The graph shows the anode voltage on the y-axis in Volts (V) and the testing time in seconds (s) on the x-axis. The graph shows that the lowest electrode voltage during the voltage swing remains higher than 0.0 V, indicating for example that no or substantially no lithium plating occurred at the anode.

In some embodiments, an anode pre-doping level for a lithium ion capacitor pouch cell, such as a cell with an operating voltage of about 2.2 V to about 3.8 V, can be selected to reduce or prevent lithium metal plating on the anode, and/or gassing at the cathode. In some embodiments, the anode pre-doping level can be selected such that the cathode voltage swing during charge and discharge of the lithium ion capacitor does not exceed 4 V, for example such that the cathode surface does not become electrochemically and/or catalytically active for gas formation. In some embodiments, the anode pre-doping level can be selected such that the cathode voltage swing during charge and discharge of the lithium ion capacitor does not exceed 4 V and no or substantially no gas generation occurs at the cathode, for example while operating under 65° C. For example, the anode pre-doping level can be selected such that the cathode voltage swing does not exceed 4 V while operating the lithium ion capacitor at an operating temperature of about 65° C.

In some embodiments, a desired pre-doping level of lithium ion capacitor pouch cell with an operating voltage of about 2.2 V to about 3.8 V is achieved when an open circuit voltage between the anode and cathode of the capacitor is about 2.7 V to about 2.95 V, such as about 2.8 V, or about 2.9 V. In some embodiments, the anode of the lithium ion capacitor pouch cell comprises hard carbon and soft carbon as the carbon configured to reversibly intercalate lithium ions.

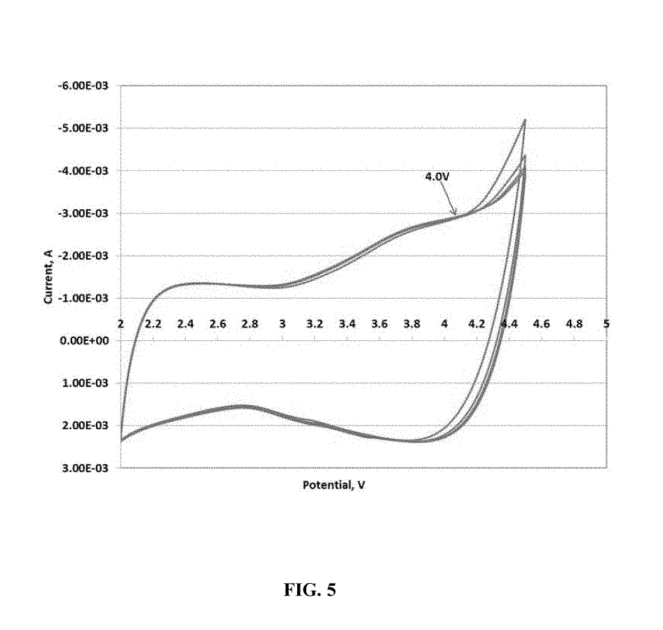

FIG. 5 is a graph showing a cyclic voltammetry curves for a cathode of a large 3.8 V lithium ion capacitor pouch cell, where the corresponding anode comprises hard carbon and soft carbon for reversibly intercalating lithium ions. The graph depicts the electrochemical stability window for activated carbon. The graph shows current, in amperes (A) on the y-axis and voltage in Volts (V) on the x-axis. The graph shows that the cathode surface becomes electrochemically and/or catalytically active for gas formation above about 4 V.

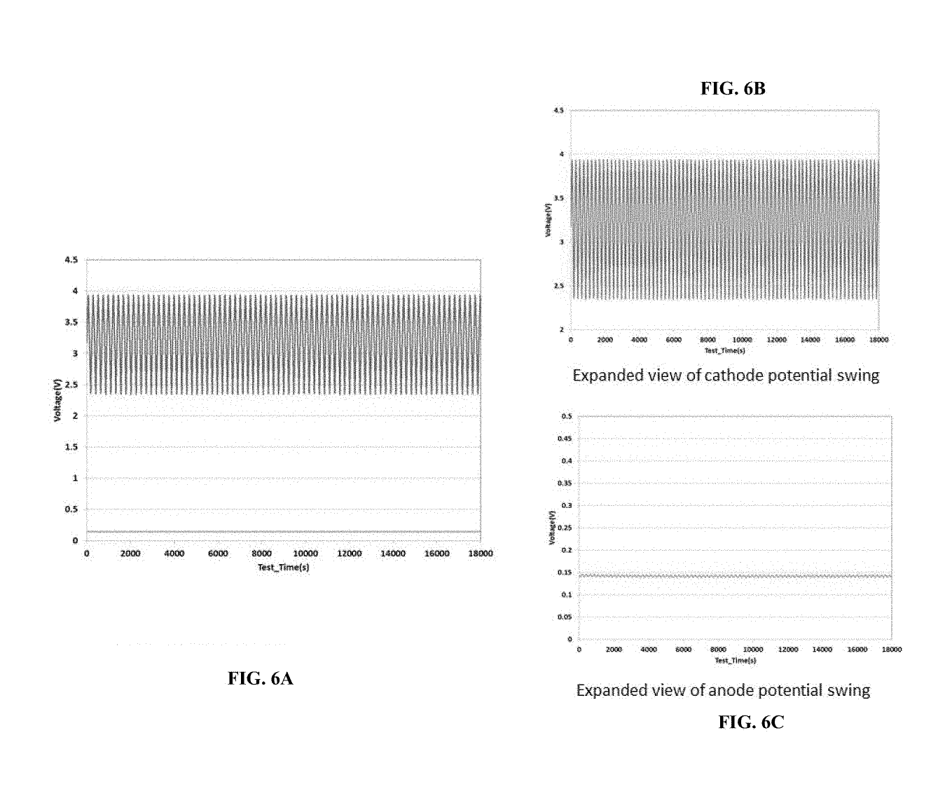

FIG. 6A is a graph showing voltage swing of the anode and cathode of a large 3.8 V lithium ion capacitor pouch cell cycled between about 2.2 V and 3.8V, where the anode comprises hard carbon and soft carbon for reversibly intercalating lithium ions. The graph shows the voltage on the y-axis in Volts (V) and the testing time in seconds (s) on the x-axis. FIGS. 6B and 6C are close up view of the voltage swing profiles of the anode and the cathode, respectively. FIG. 6A, FIG. 6B and FIG. 6C were measured using capacitors pre-doped to an open circuit cell voltage of 2.9 V.

### Methods

In some embodiments, a method for fabricating an energy storage device is provided, comprising: electrically coupling a lithium metal source and an electrode film; doping the electrode film with lithium ions to a predetermined electrode voltage, where the predetermined electrode voltage is about 0.05 to about 0.3 V compared to an Li/Li+ reference voltage. The predetermined electrode voltage can be selected to limit lithium metal plating and to limit gassing, as described herein. In further embodiments, the energy storage device electrode can be a capacitor anode. In further embodiments, the electrode film can be a free-standing electrode film manufactured by a dry process as described herein. In further embodiments, the lithium metal source comprises elemental lithium, for example, as chunks, foil, sheet, bar, or rod. As used herein, elemental lithium metal refers to lithium metal having an oxidation state of zero. In still further embodiments, the lithium metal source is within the housing of the energy storage device. In yet further embodiments, the method includes the step of placing the lithium metal source in contact with the electrode film. In some embodiments, the method includes the step of placing a separator between the lithium metal source and the electrode film.

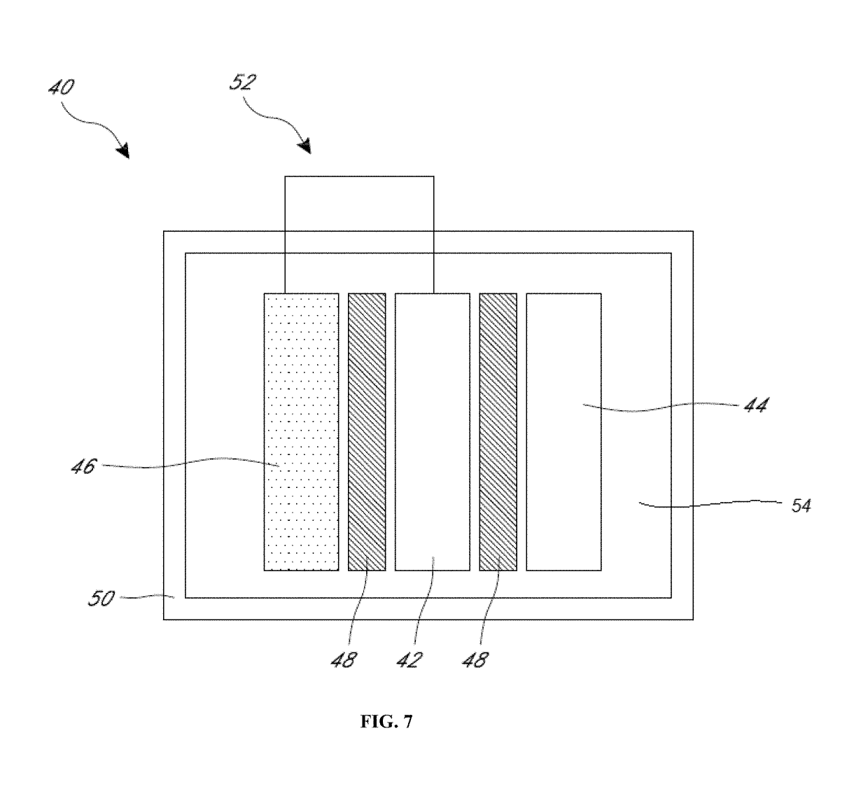

Referring to FIG. 7, in one embodiment, an anode 42 of a lithium ion capacitor 40 can be pre-doped by shorting a dopant source 46 to the anode 42. The dopant source 46 can comprise a source of lithium.

FIG. 7 depicts an apparatus for pre-doping a lithium ion capacitor anode 42. The apparatus can include a dopant source 46 and the anode 42 immersed in an electrolyte 54. In some embodiments, the dopant source 46 can comprise a source of lithium ions. For example, the dopant source 46 can comprise lithium metal. The dopant source 46 may be positioned on a face of anode 42, and may be positioned along a face so that lithium source 46 is exposed to an electrode film of anode 42. For example, the dopant source 46 may be placed to a side of the anode 42 opposite that facing the capacitor cathode 44. In some embodiments, the pre-doping apparatus can include a separator 48 between the dopant source 46 and the anode 42. The separator 48 may be configured to permit a transport of ionic species (e.g., lithium ions) between the anode 42 and the dopant source 46. In some embodiments, the separator 48 can be made of a porous electrically insulating material (e.g., a material comprising a polymer, including a cellulosic material), and/or can comprise a separator material provided herein.

In some embodiments, pre-doping a lithium ion capacitor anode 42 can be performed in-situ. Referring to FIG. 7, in some embodiments, pre-doping a lithium ion capacitor 42 can be performed in a lithium ion capacitor cell 40 comprising the anode 42, the dopant source 46, a capacitor cathode 44, and a separator 48 between the anode 42 and cathode 44, and a separator 48 between the anode 42 and the dopant source 46. The anode 42, the dopant source 46, the cathode 44, and the separators 48 may be immersed in an electrolyte 54. The dopant source 46 may be consumed during the pre-doping step. In some embodiments, the dopant source 46 may be completely or substantially consumed during the pre-doping step. In some embodiments, at least a portion of the dopant source 46 remains after the constant voltage pre-doping step, whereupon any remaining dopant source 46 is removed upon completion of the pre-doping process. In some embodiments, any remaining dopant source 46 can be removed from a lithium ion capacitor 40 and the lithium ion capacitor 40 can subsequently be sealed.

In some embodiments, an electrical conductor 52 can be positioned between the anode 42 and the dopant source 46. The electrical conductor 52 can provide electrical contact between the anode 42 and the dopant source 46. During a pre-doping process, dopants at the dopant source 46 may be released. For example, lithium metal at dopant source 46 comprising a lithium metal electrode may be oxidized to provide lithium ions. The lithium ions thus produced can be incorporated into anode 42.

The level of anode pre-doping may be performed to provide a pre-determined level of doping. In some embodiments, the level may be based at least in part on a desired lithium ion capacitor performance. For example, the level of pre-doping or duration over which pre-doping is performed may be selected based at least in part on a desired ESR performance or capacitance fade performance. In further embodiments, the level or duration of pre-doping may be based at least in part on limiting gassing or lithium metal plating.

Although this invention has been disclosed in the context of certain embodiments and examples, it will be understood by those skilled in the art that the invention extends beyond the specifically disclosed embodiments to other alternative embodiments and/or uses of the invention and obvious modifications and equivalents thereof. In addition, while several variations of the embodiments of the invention have been shown and described in detail, other modifications, which are within the scope of this invention, will be readily apparent to those of skill in the art based upon this disclosure. It is also contemplated that various combinations or sub-combinations of the specific features and aspects of the embodiments may be made and still fall within the scope of the invention. It should be understood that various features and aspects of the disclosed embodiments can be combined with, or substituted for, one another in order to form varying modes of the embodiments of the disclosed invention. Thus, it is intended that the scope of the invention herein disclosed should not be limited by the particular embodiments described above.

The headings provided herein, if any, are for convenience only and do not necessarily affect the scope or meaning of the devices and methods disclosed herein.

What is claimed is:

1. An energy storage device comprising:
a cathode;
an anode comprising intercalated lithium ions; and
a separator between the cathode and the anode;
wherein the intercalated lithium ions are present in an amount selected to limit lithium metal plating and to limit gassing; and
wherein the amount of intercalated lithium ions corresponds to an anode voltage of about 0.05 to about 0.3 V compared to an Li/Li⁺ reference voltage.

2. The energy storage device of claim 1, wherein the energy storage device has an open circuit cell voltage of 2.7 V to 2.95 V following pre-doping and before use.

3. The energy storage device of claim 1, wherein the lithium metal plating occurs at an anode voltage of about 0 V compared to an Li/Li⁺ reference voltage.

4. The energy storage device of claim 1, wherein the gassing occurs at a cathode voltage of about 4 V compared to an Li/Li⁺ reference voltage.

5. The energy storage device of claim 1, further comprising an electrolyte comprising a lithium salt.

6. The energy storage device of claim 5, wherein the electrolyte further comprises a carbonate.

7. The energy storage device of claim 1, wherein the anode comprises an electrode film mixture comprising a carbon material selected from graphite, hard carbon, and soft carbon.

8. The energy storage device of claim 1, wherein the anode comprises an electrical conductivity promoting material.

9. The energy storage device of claim 1, wherein the energy storage device is a capacitor.

10. The energy storage device of claim 1, wherein the anode comprises a dry, free-standing electrolyte film and a current collector.

11. An energy storage device comprising:
a first electrode comprising lithium ions adsorbed to a first electrode surface;
a second electrode;
a separator between the first electrode and the second electrode; and
an electrolyte comprising a lithium salt;
wherein the lithium ions are present on the first electrode surface in an amount corresponding to a first electrode voltage of about 0.05 to about 0.3 V following pre-doping, and before use, compared to an Li/Li⁺ reference voltage.

12. The energy storage device of claim 11, wherein the energy storage device has an open circuit cell voltage of 2.7 V to 2.95 V following pre-doping, and before use.

13. The energy storage device of claim 11, wherein the first electrode and the second electrode each comprise a dry, free-standing electrode film and a current collector.

14. The energy storage device of claim 13, wherein the first electrode and the second electrode each comprise an electrode film substantially free from processing additives.

15. The energy storage device of claim 11, wherein the lithium salt is lithium hexafluorophosphate (LiPF₆).

16. The energy storage device of claim 11, wherein the electrolyte further comprises a carbonate.

17. The energy storage device of claim 16, wherein the carbonate is selected from the group consisting of ethylene carbonate (EC), propylene carbonate (PC), vinyl ethylene carbonate (VEC), vinylene carbonate (VC), fluoroethylene carbonate (FEC), dimethyl carbonate (DMC), diethyl carbonate (DEC), ethyl methyl carbonate (EMC), and combinations thereof.

18. The energy storage device of claim 11, wherein the first electrode comprises a carbon material selected from graphite, hard carbon, soft carbon, and combinations thereof.

19. The energy storage device of claim 11, wherein the first electrode further comprises an electrical conductivity promoting material.

20. The energy storage device of claim 11, wherein the energy storage device is a capacitor.

21. A method for fabricating an energy storage device comprising:
electrically coupling a lithium metal source and an electrode film; and
doping the electrode film with lithium ions to a predetermined electrode voltage of about 0.05 to about 0.3 V compared to an Li/Li⁺ reference voltage.

22. The method of claim 21, wherein the electrode is an anode.

23. The method of claim 21, wherein the electrode film is a capacitor electrode film.

24. The method of claim 21, wherein the predetermined electrode voltage is selected to limit lithium metal plating and to limit gassing.

25. The method of claim 21, wherein the electrode film is manufactured by a dry process.

26. The method of claim 25, wherein the electrode film is a free-standing electrode film.
